(19) United States
(12) Patent Application Publication
(10) Pub. No.: US 2024/0054913 A1
(43) Pub. Date: Feb. 15, 2024

(54) SCIENCE TEACHING SYSTEM AND METHOD FOR USING SAME, AND COMPUTER-READABLE STORAGE MEDIUM

(71) Applicant: Qingheng CAO, Beijing (CN)

(72) Inventor: Qingheng CAO, Beijing (CN)

(21) Appl. No.: 18/466,573

(22) Filed: Sep. 13, 2023

Related U.S. Application Data
(63) Continuation of application No. PCT/CN2021/080649, filed on Mar. 13, 2021.

(51) Int. Cl. G09B 23/00

(52) U.S. Cl. CPC G09B 23/00

(57) ABSTRACT

The present invention discloses a science teaching system and a method for using same, and a computer-readable storage medium. The science teaching system comprises: a data acquisition module, an analysis module, and a database module. The method for using a science teaching system comprises: obtaining data of science learning/practicing of a user; analyzing and assessing a science multidimensional ability of the user by means of the data of science learning/practicing of the user; and recommending a science teaching plan suitable for the user according to the science multidimensional ability of the user and related information of personal science learning/practicing of the user.

### CROSS-REFERENCE TO RELATED APPLICATIONS

This application is a continuation of International Patent Application No. PCT/CN2021/080649 with a filing date of Mar. 13, 2021, designating the United States, now pending. The content of the aforementioned applications, including any intervening amendments thereto, are incorporated herein by reference.

### TECHNICAL FIELD

The present invention relates to the technical field of teaching equipment, in particular to a science teaching system and a method for using same, and a computer-readable storage medium.

### BACKGROUND OF THE PRESENT INVENTION

In addition to reading, listening and memory, repeated practicing of a large number of different types of exercises is required for users to gradually master the science learning. Through the practicing of different types of exercises with different difficulties, on the one hand, the users can be guided to master the relevant knowledge and methods from easy to difficult, and on the other hand, the users or tutors can be helped to find the mastery of the users for the related knowledge and methods, so as to strengthen learning and teaching more pertinently. Especially for the parts not understood and grasped well by the users, the relevant learning results can be effectively consolidated and the learning efficiency of the users can be increased through targeted reinforcement of practicing. At present, there are many systems, platforms or solutions that can push different learning contents and exercises with different difficulties according to the differences in the learning levels of the users in various knowledge points, so as to achieve relatively individualized learning and practicing.

However, the reality is that, in order to really learn the science well, the users not only rely on the accumulation of various knowledge points, but more importantly, the users shall establish and skillfully master the corresponding science knowledge application system, including calculation ability, understanding ability, analysis ability, and knowledge points and methods that need to be memorized. At the same time, the users also need to master the effective thinking mode of problem-solving and establish their own feasible problem-solving methods and processes. The existing system, platform and solution cannot further analyze the key links that need to be mainly mastered and practiced by the users, cannot push more accurate contents for the users pertinently, can only perform a match conventionally according to knowledge points, exercise types, difficulties and the corresponding learning unit results of the users. This, in turn, fails to fully eliminate the learning mode involving large-scale repetitive practice for users.

The application of the modern information technology for accurate analysis of the actual user situation of mastering the relevant knowledge and methods, targeted combination and provision of exercise sets and dynamic optimization of practicing modes and contents according to the answer situations can allow the users to find and master the parts that they need to further learn and improve through the shortest practicing time, so as to help the users to master the relevant knowledge and abilities rapidly.

### SUMMARY OF PRESENT INVENTION

The main purpose of the present invention is to provide a science teaching system and a method for using same, and a computer-readable storage medium. The science learning/practice data of users is acquired through the analysis and evaluation of the users' science multidimensional abilities using established assessment criteria for science multidimensional abilities. A suitable, dynamic and individualized science teaching plan can be formulated for the user according to a personal ability and a goal of the user, and standardized guidance reminding and correction can be provided in the practicing process, so that the science learning of the user is efficient, convenient and low in cost.

To achieve the above purpose, the present invention provides a science teaching system, which comprises: a data acquisition module, an analysis module and a database module.

The data acquisition module is used for obtaining the data of science learning/practicing of a user.

The database module is used for storing a science multidimensional ability database and a user personal science database; the science multidimensional ability database comprises the assessment standard of the science multidimensional ability; and the user personal science database stores the related information of the personal science learning/practicing of the user.

The analysis module is used for analyzing and assessing the science multidimensional ability of the user through the data of science learning/practicing of the user and recommending a science teaching plan suitable for the user according to the science multidimensional ability of the user and the related information of personal science learning/practicing of the user.

In the above science teaching system, the science multidimensional ability comprises at least one ability in understanding, analysis, model/model group establishment, combination of knowledge points, step by step implementation, problem-solving path selection, problem-solving node combination, formula memory, calculation, concentration, psychology and proficiency.

The above science teaching system further comprises setting corresponding levels/scores respectively according to the assessment results of each ability of the science multidimensional ability of the user, and setting a comprehensive analysis model of the multidimensional ability comprising the analysis results of each ability according to the actual situation of the user, so as to assess the corresponding levels/scores and the comprehensive analysis model which comprises the comprehensive analysis results and the relationship of each analysis item according to each ability of the user in the science multidimensional ability. Within the certain knowledge system, the levels/scores of the comprehensive science ability of the user are assessed for recommending a suitable science teaching plan for the user.

In the above science teaching system, the science teaching plan comprises a learning plan and/or a practicing plan; the learning plan comprises learning of specific teaching content and review and summary of the specific teaching content after practicing; and the practicing plan comprises practicing goals, difficulty, exercises, practicing points, methods and skills, practicing time and completion standards.

In the above science teaching system, the science multidimensional ability database further comprises learning content/exercise sources on which annotated content/exercises based, grade levels, curricula, difficulty levels, categories, learning/problem-solving aspects, as well as the involved knowledge points and relevant formulas.

The above science teaching system can also recommend teaching video/audio/text/picture materials suitable for the user according to the science multidimensional ability of the user and the related information of personal science learning/practicing of the user.

The above science teaching system further comprises adjusting or re-recommending a science teaching plan suitable for the user according to the actual situation of the science learning/practicing of the user.

The above science teaching system can also perform intelligent analysis and feedback according to the actual situation of the science learning/practicing of the user. The feedback comprises: at least one of feeding the analysis results back to the user to enable the user to make targeted improvement; feeding the analysis results back to teachers/parents in real time so that the teachers/parents conduct manual intervention; and issuing an assessment report according to the analysis results.

The present invention further provides a method for using the above science teaching system, which comprises:

obtaining data of science learning/practicing of a user;

analyzing and assessing a science multidimensional ability of the user by means of the data of science learning/practicing of the user;

recommending a science teaching plan suitable for the user according to the science multidimensional ability of the user and related information of personal science learning/practicing of the user.

The present invention further provides a computer-readable storage medium which stores a computer program. When a processor executes the computer program, steps of the method for using the science teaching system are realized.

In the science teaching system and the method for using same, and the computer-readable storage medium in the present invention, the science teaching system comprises: the data acquisition module, the analysis module and the database module. The method for using the science teaching system comprises: obtaining data of science learning/practicing of the user; analyzing and assessing the science multidimensional ability of the user by mans of the data of science learning/practicing of the user; and recommending a science teaching plan suitable for the user according to the science multidimensional ability of the user and the related information of the personal science learning/practicing of the user. In the science teaching system and the method for using same, and the computer-readable storage medium in the present invention, the data of science learning/practicing of the user is obtained by establishing the assessment standard of the science multidimensional ability to analyze and assess the science multidimensional ability of the user. A suitable, dynamic and individualized science teaching plan can be formulated for the user according to the personal ability and goal of the user, and the learning materials can be recommended; and the defect in the learning process of the user can also be intelligently analyzed, such that the user can perform a targeted correction, and thus the science learning of the user is efficient, convenient and low in cost.

### DESCRIPTION OF THE DRAWINGS

FIG. 1 is a schematic diagram of a science teaching system in a first embodiment of the present invention.

FIG. 2 is a method flow chart of a use method of a science teaching system in a second embodiment of the present invention.

### DETAILED DESCRIPTION OF PREFERRED EMBODIMENTS

To further illustrate the technical means adopted by the present invention to achieve the intended purpose and the effect, specific implementation modes of the present invention are explained in detail below in combination with drawings and embodiments.

The science teaching system of the present invention can be used for subjects of mathematics, physics, chemistry and biology, and can also be used for other suitable science subjects.

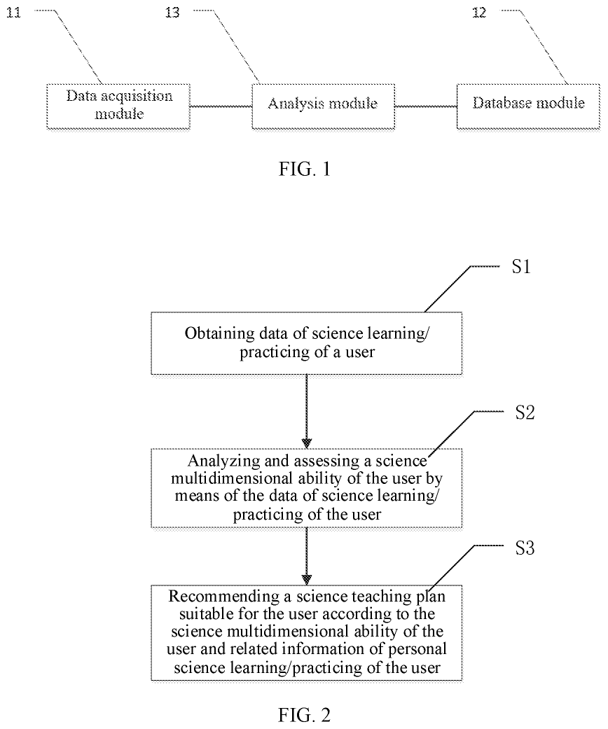

A first embodiment of the present invention is shown in FIG. 1. FIG. 1 is a schematic diagram of a science teaching system in the first embodiment of the present invention. As shown in the figure, the science teaching system of the present invention comprises: a data acquisition module 11, a database module 12 and an analysis module 13.

The data acquisition module 11 is used for obtaining the data of science learning/practicing of the user. The data of science learning/practicing of the user may comprise: answer contents such as science test papers/exercise sets/exercise books/workbooks, answers to classroom questions, discussion of exercises, and data of learning/practicing on teaching software that can reflect a science level of the user. The science teaching system of the present invention can obtain the contents of the test papers, the exercise sets, the exercise books and the workbooks through the data acquisition module 11 such as a scanner, or record a class video through an image sensor and analyze the class video to obtain the contents of the answers to classroom questions and discussion of exercises, or the user/teacher/parent inputs the data that can reflect the science level of the user through computer input equipment such as a keyboard and a mouse, or obtains the data of science learning/practicing of the user from other systems/databases through a relevant data interface.

In the present invention, the data of science learning/practicing of the user obtained by the data acquisition module 11 can come from different sources, and has different data structures, different descriptions and different data standards. The data from different sources can be standardized through dictionary matching, speech recognition technology, semantic recognition technology, translation of different languages, OCR recognition technology, virtual reality technology and augmented reality technology to facilitate subsequent automatic processing.

The database module 12 is used for storing a science multidimensional ability database and a user personal science database. The science multidimensional ability database comprises the assessment standard of the science multidimensional ability. The science multidimensional ability comprises at least one ability in understanding, analysis, model/model group establishment, combination of knowledge points, step by step implementation, problem-solving path selection, problem-solving node combination, formula memory, calculation, concentration, psychology and proficiency, can also comprise a combination ability of two or more individual abilities, and can also comprise a completion ability of exercises of various grades/difficulties, and the relationships among the completion ability, the combination ability and the individual abilities. In the present invention, a model refers to a scenario that is virtually established to solve one problem or a class of problems, and a model group is combined by more than one model. Step by step implementation refers to the conversion of a complex exercise into multiple models/model groups to solve them step by step in a certain order. A problem-solving node refers to a smallest unit in the process of problem-solving, which can be a single-step calculation or a single-parameter insertion. A problem-solving path refers to a path that comprises more than one problem-solving node and completely covers the problem-solving process from the exercise to the answer. Each exercise can have many different problem-solving paths which can obtain a right answer.

The problem-solving path can have many steps/branches/layers. When exercises are deconstructed, a model is obtained, and this model can also have many steps/branches/layers. Each upper model can be combined by a plurality of lower models, and the lower model can also be combined by a plurality of models of the next layer. The model corresponds to one or more knowledge points. The knowledge points can comprise: constants, formulas, formulation, functions, definitions, laws, theorems, deformation, transformation, analogy, transfer, methods, similarity, same, mirror, rotation, planes, solid, algebra, trigonometric functions, statistics and calculation ability.

For example, if the domain of definition of exercise g(y²+y) is (0,2), what is the domain of definition of g(y²+2y+1)?
(1) Understanding: this exercise focuses on the understanding of the domain of definition, even if the function makes sense for all real numbers.
(2) Analysis: from the given range of the domain of definition of y²+y, y²+2y+1 is substituted for solving.
(3) Model establishment: a model for solving the domain of definition is established, that is, the range of a variable expression in parentheses is obtained firstly through known conditions, and then a variable expression to be solved is substituted for solving.
(4) Combination of knowledge points: the knowledge points of this exercise comprise the domain of definition of the function and the solving of a quadratic equation with one unknown.
(5) Step by step implementation: this exercise is divided into three steps. Firstly, 0<y²+y<6 is obtained through the domain of definition [0,2] of the exercise g(y²+y), and then 0<y²+2y+1<6 is obtained by substituting the variable expression to be solved. Finally, the exercise is solved.
(6) Problem-solving path selection: there are two paths for solving 0<y²+2y+1<6;
the first path is obtaining −\sqrt{6}−1<y<\sqrt{6}−1 and y≠−1 from 0<(y+1)²<6;
the second path is to directly substitute it into the solving formula of the quadratic equation with one unknown to obtain −\sqrt{6}−1<y<\sqrt{6}−1 and y≠−1;
(7) Combination of problem-solving nodes: the problem-solving nodes comprise each step of the problem-solving path, comprising single-step calculation or single-parameter insertion, which is not repeated here.
(8) Formula: the formula in this exercise is mainly the solving formula of the quadratic equation with one unknown,

$$y = \frac{- b \pm \sqrt{{b}^{2} - 4 a c}}{2 a} ;$$

(9) Calculation: comprising the calculation of the range of the known variable expression from the known domain of definition, the calculation of the variable expression to be solved, and the calculation of the process of solving the quadratic equation with one unknown, which will not be repeated here.
(10) In addition, the concentration, psychology and proficiency in the science multidimensional ability of the user can be analyzed from the problem-solving time, writing norms, existence of mistakes, the types of the mistakes and the reasons for the mistakes. If the exercise is solved correctly and the time is short, then the proficiency is high; if the writing is standard without mistake, then the concentration ability is high; if the exercise is solved in usual homework but mistakes are made in an exam, then the mental ability is poor, and so on.

The science multidimensional ability database can also comprise: the mastery range and list of exercises of various grades/difficulties, the standards and requirements of various one-dimensional abilities, combination abilities and completion abilities corresponding to the exercises of various grades/difficulties, various exercises and solutions, knowledge points and related learning contents, related contents of models/model groups, analysis methods, problem-solving methods/paths/nodes, node combination and path selection, various formulas, relationships among knowledge points/models/formulas/problem-solving methods and relationships of exercises with knowledge points/models/formulas/problem-solving methods, and also comprises marking the sources on which the learning content/exercise is based, grades, courses, difficulties, types, learning/problem-solving points, knowledge points involved, and formulas involved. The appropriate exercises for inclusion in the pedagogical plan for a user can be determined through the marks. The knowledge points and learning contents can comprise: the names of the knowledge points, grades, numbers, key words, the contents of the knowledge points, difficulties, importance, test frequency, the types of the knowledge points, reference materials, learning suggestions, associated knowledge points/models/formulas/problem-solving methods, associated exercise and learning materials. Various exercises and solutions can comprise: various exercises and exercise sources, grades, numbers, exercise contents, exercise categories, exercise difficulties, exercise solutions, reference materials, associated knowledge points/models/formulas/problem-solving methods and degree of association, exercise mastery requirements and examination frequency. The exercise solutions and the reference materials can be in text/picture/audio/video or other forms.

The user personal science database stores the related information of the personal science learning/practicing of the user, and is used for providing the related information of the personal science learning/practicing of the user in the process of analyzing and assessing the science multidimensional ability of the user and recommending a science teaching plan suitable for the user. The related information of the personal science learning/practicing of the user may comprise: the basic information of the user, schools, teachers, grade, learning goals, personal science ability, personal science characteristics, various abilities related to science, mastered problem-solving methods/techniques/skills, practicing time, exercise records and learning progress, as well as the historical assessment information and corresponding related data of the science multidimensional ability of the user, wherein the basic information of the user comprises: name, age, gender, height, weight and family situation. The personal science ability can comprise: the class/level of the one-dimensional ability and the combination ability of the science multidimensional ability of the user, the completion ability of the mastered various exercises of different grades/difficulties of the user, and the corresponding level and proficiency. The personal science characteristics can comprise: exercise types that the user likes/dislikes, exercise backgrounds, objects, problem-solving methods, techniques and skills; exercise types that the user is good at/not good at, exercise backgrounds, objects, problem-solving methods, techniques and skills. Various abilities related to science comprise: IQ, memory, reaction ability, coordination ability, logical reasoning ability, abstract thinking ability, spatial imagination ability, physical strength and endurance.

In the present invention, the science multidimensional ability database and the user personal science database are established based on various teaching materials, syllabi, tutoring materials, expert experience/consensus, educational papers and works, relevant systems and guidance opinions, exercise sets, test papers and exercise banks by selecting suitable learning contents and exercises and obtaining relevant data, or established through artificial intelligence analysis of the existing data and synthesis according to specifications, or established through new data obtained by data mining/data reorganization/statistical analysis. The data acquisition methods of the science multidimensional ability database and the user personal science database can comprise input by the user/teacher/parent, acquisition from other information systems, equipment or databases, or new data continuously obtained and analyzed in the use process of related information of the database, or a combination of the above methods.

The analysis module 13 is used for analyzing and assessing the science multidimensional ability of the user through the data of science learning/practicing of the user and recommending a science teaching plan suitable for the user according to the science multidimensional ability of the user and the related information of personal science learning/practicing of the user.

The analysis module 13 analyzes and assesses the science multidimensional ability of the user through the data of science learning/practicing of the user, which can extract feature data required for assessment from the data of science learning/practicing of the user, then compare the extracted feature data with the assessment standard of the science multidimensional ability in the science multidimensional ability database, and assess the ability of the user in each dimension of the science multidimensional ability from the dimensions of understanding, analysis, model/model group establishment, combination of knowledge points, step by step implementation, problem-solving path selection, problem-solving node combination, formula memory, calculation, concentration, psychology and proficiency. The analysis module can also assess the combination ability of two or more individual abilities of the science multidimensional ability of the user, and can also assess the completion ability of various exercises of different grades/difficulties.

The feature data required to assess the science multidimensional ability is extracted from the data of science learning/practicing of the user, such as science papers/exercise sets/exercise books/workbooks/answers to classroom questions/discussion of exercises, etc. Accuracy, error types, error severity, error causes, dimensions including comprehension, analysis, model/model group establishment, knowledge point combination, step-by-step implementation, problem-solving path selection, problem-solving node combination, formula retention, calculation, concentration, and their associations and occurrence frequencies can be extracted from data related to science papers/exercise sets/exercise books/exercise notebooks/classroom question answers/exercise discussions, providing insights into psychology and proficiency. These extracted characteristics are then compared against the assessment criteria for science multidimensional abilities to analyze the user's abilities across various dimensions. The assessment standard of the science multidimensional ability can set different grading assessment standards according to the requirements of syllabi of different ages and different feature data such as correct rate, mistake type, mistake degree, mistake reason, association and occurrence frequency of each dimension. For example, the calculation ability is level 1 if the correct rate is greater than or equal to 98%, is level 2 if the correct rate is between 90% and 98% and an association coefficient is less than 0.1, and is level 3 if the correct rate is less than 90%.

The science teaching system of the present invention can also set corresponding levels/scores respectively according to the assessment results of each ability of the science multidimensional ability of the user. This allows for the analysis of the user's abilities in practical scenarios and the development of a comprehensive analysis model that encompasses relationships between the respective levels/scores, inclusive of a composite analysis result and each analytical aspect. Within the certain knowledge system, the levels/scores of the comprehensive science ability of the user are assessed for recommending a suitable science teaching plan for the user. The score/level can also consider the age and development prospects of the user, and higher scores/levels are given to a user with small age/good development prospects. The comprehensive analysis model is a model used for analyzing and assessing the science multidimensional ability of the user, which can be manually set by experts/senior teachers, or obtained through data statistics/analysis, or obtained through information reorganization/big data analysis, or obtained through artificial intelligence deep learning/optimization, and can be continuously accumulated and optimized in the process of use.

F is the level/score of the comprehensive ability, fᵢ is the level/score corresponding to the assessment result of the i^{th} ability, and S(fᵢ) is an analytical model formula related to the i^{th} ability. The specific calculation formula is as follows:

F=Σᵢ₌₁ⁿS(fᵢ)

After assessing the science multidimensional ability of the user, the analysis module 13 recommends a science teaching plan suitable for the user according to the science multidimensional ability of the user and the related information of the personal science learning/practicing of the user. The science teaching plan comprises a learning plan and/or a practicing plan. The learning plan comprises learning of specific teaching content and review and summary of the specific teaching content after practicing. The learning of the specific teaching content can be in the form of text, video, interactive programs and manual remote mode, and can also comprise prompts in the learning process.

The practicing plan comprises practicing goals, difficulty, exercises, practicing points, methods and skills, practicing time and completion standards. The practicing goals can be to improve scores, pass examinations/tests, improve the science multidimensional ability or individual abilities and combination abilities therein, and improve the completion ability of various exercises of different grades/difficulties, can also be to improve various abilities related to science, such as IQ, memory, reaction ability, coordination ability, logical reasoning ability, abstract thinking ability, spatial imagination ability, physical strength, endurance and problem-solving methods/techniques/skills, and can also be a combination of the above goals.

The science teaching system of the present invention can recommend a science teaching plan suitable for the user according to the actual situation of the user, comprising the science multidimensional ability of the user and the related information of the personal science learning/practicing of the user, and the characteristics of the practicing intensity and practicing time of the user. The teaching plan can be a single teaching plan, a comprehensive teaching plan over a period of time, or a teaching plan for a specific examination/exercise.

Recommending a suitable science teaching plan for the user comprises:

A user goal is determined. The user goal may be to achieve a certain level of science multidimensional ability or to achieve a certain degree of exercise completion ability, to achieve a certain examination/test score, or a combination of the above.

Tasks of ability improvement required for achieving the goal are calculated according to the user goal and the current status of the science multidimensional ability and the exercise completion ability of the user.

Then, an individualized science teaching plan for the user is formulated according to the tasks and in combination with the actual situation of the user.

The science teaching plan can comprise a learning plan and/or a practicing plan. Learning content suitable for the learning plan can be selected. The exercise plan is formulated by selecting exercises from the science multidimensional ability database that correspond to the user's scores, and generating exercises or combinations thereof that encompass task requirements and align with the user's practical circumstances, based on difficulty/method skills/exercise points. For example, according to the current science multidimensional ability of the user and the gap between the exercise completion ability and the goal, the task calculated by analysis is to improve three abilities from level 1 to level 2 respectively, then select the learning contents and exercises in line with the current task from the database, and generate the teaching plan in combination with the practicing time, etc. of the user.

In the present invention, if the gap between the goal and the existing ability is large, the goal can also be decomposed into a plurality of subgoals, and the task can also be decomposed into a plurality of corresponding subtasks. For example, the abilities of the science multidimensional ability are divided into ten levels. The user goal is to achieve level 8 for the analysis ability and the calculation ability and to skillfully complete the exercises of the quadratic equation with one unknown. The current analysis ability of the user is level 6, and the calculation ability is level 7. The user cannot complete the exercises of the quadratic equation with one unknown. Then, the task of the user is to improve the analysis ability from level 6 to level 8 and calculation ability from level 7 to level 8, and to have the completion ability of the exercises of the quadratic equation with one unknown. Due to the large gap span between the goal and the existing ability, the goal can be decomposed into a plurality of subgoals: level 7 for the analysis ability, level 8 for the calculation ability, level 8 for the analysis ability and proficiency in completing the exercises of the quadratic equation with one unknown. Accordingly, the task can also be decomposed into a plurality of subtasks: from level 6 to level 7 for the analysis ability, from level 7 to level 8 for the calculation ability, from level 7 to level 8 for the analysis ability, and possessing of the ability to complete the exercises of the quadratic equation with one unknown. The subgoals and the corresponding subtasks can also be one-dimensional abilities and combination abilities of the science multidimensional ability, and completion abilities of the exercises, or a combination thereof, which will not be limited here.

Then, it is necessary to formulate corresponding subplans according to each subtask. Each subplan can cover the corresponding subtask, and then the subplans are integrated to form a complete teaching plan. The teaching plan can completely cover the whole task and satisfy the requirements of the complete goal. The subplans can also be optimized so that the integrated teaching plan achieves the best efficiency and effect.

The calculation dimensions of subplan formulation and optimization can comprise:
1. The learning/practicing tasks of all task units of this goal are comprehensively covered, so as to be accurate and not missing.
2. New unmastered/unskilled question points are not included as much as possible.
3. A minimum learning/practicing range required to complete the task shall be used.
4. A minimum practicing intensity required to complete the task shall be used, including time and content complexity, and removal of redundant exercises with high similarity.
5. Exercises/contents that the user is interested in shall be selected.

The science teaching plan generated by the science teaching system of the present invention can be one or more. The science teaching system can also set corresponding levels/scores respectively according to the assessment results of different dimensions, and can set the weight of each dimension according to the actual situation of the user, so as to obtain the comprehensive level/score of the science teaching plan for assessment and comparison of different plans. The science teaching system can recommend the teaching plan with the highest comprehensive level/score for the user, or manually or automatically set a recommendation threshold. The teaching plan with the comprehensive level/score higher than the threshold will be recommended, and selected by the user, teacher or parents. Assessment dimensions can comprise: the length of time required, the scores improved, the length of memory time, the level of user interest/initiative, etc.

X is the comprehensive level/score of the science teaching plan, xⱼ is the level/score corresponding to the result of the j^{th} dimension, and kⱼ is the corresponding weight with the j^{th} dimension. The specific calculation formula is as follows:

X=Σⱼ₌₁^{m}kⱼxⱼ

The science teaching system of the present invention stores a plurality of science teaching plans suitable for various archetypal individuals and different users, along with pertinent information about the individual scientific learning/practice of diverse users. These science teaching plans can be manually set by experts/senior teachers, or obtained through data statistics/data analysis, or obtained through information reorganization/big data analysis, or obtained through artificial intelligence deep learning/optimization, and can be continuously accumulated and optimized in the process of use. The science teaching plan suitable for the user is recommended according to the actual situation of the user, which specifically analyzes and compares the conformance of the science multidimensional ability of the user and the related information of the personal science learning/practicing of the user with the existing model, selects the existing science teaching plan which is the most suitable for the user, and considers the difference between the actual situation of the user and the existing model to properly adjust the plan to make the plan more suitable for the actual situation of the user. Adjustment can be done manually by professionals, automatically by the system by means of preset rules, or automatically by artificial intelligence through self-learning.

The science teaching system of the present invention can also be a teaching plan for the user. The progress of the user can be obtained by analyzing the data of the science learning/practicing of the user, and the implementation of the teaching plan can be promoted according to the actual progress, so that the implementation effect of the teaching plan can be greatly improved.

The science teaching system of the present invention can also intelligently analyze the situations that need attention in the learning/practicing process of the user according to the data of the science learning/practicing of the user and in combination with the science multidimensional ability of the user, to remind the user to pay attention. The science teaching system can also comprise a display module for displaying the teaching contents and the information reminded for the user to pay attention. The information reminded for the user to pay attention can be displayed on the display module in the form of text or pictures or videos, or displayed in a highlighted way in combination with the teaching contents, and for example, displayed in a changed color or by bolding the places to remind attention, or reminded for the user to pay attention by voice or other modes.

The science teaching system of the present invention can also visually elucidate the problem-solving process. The learning process can be clear and the learning effect is obvious through the visual exercise decomposition, the corresponding visual display of the multidimensional ability on the exercise, the corresponding visual display on the learning content, and the corresponding visual display on the overall/local level. Specific visual display can comprise: scenario understanding, model/decomposition (all layers: logic layer, theorem/law/axiom/common sense, quantity layer, data relationship layer (data transformation), formula layer, calculation layer (calculation skills, speed and accuracy), memory, normalization, etc.

The science teaching system of the present invention can also perform intelligent analysis and feedback according to the actual situation of the science learning/practicing of the user. The feedback comprises: at least one of feeding the analysis results back to the user to enable the user to make targeted improvement; feeding the analysis results back to teachers/parents in real time so that the teachers/parents conduct manual intervention; and issuing an assessment report according to the analysis results.

The science teaching system of the present invention can also intelligently analyze the actual situation of the science learning/practicing of the user and feed the analysis results back to the user, so that the user can keep the correct part and correct the wrong part pertinently to continuously improve the science level. After the user implements the science teaching plan, the science teaching system can analyze and assess the data of the science learning/practicing of the user, feed the results of analysis and assessment back to the user, specifically point out the defects in the learning/practicing process of the user, and feed the standard audio or video back to the user, so that the user can perform a targeted correction. As a tool for science teaching, the science teaching system of the present invention can help the user to analyze whether the completed exercises are correct to continuously improve the science level.

The science teaching system of the present invention can also comprise real-time feedback in the science learning/practicing process of the user so as to perform manual intervention by the teacher/parent. Through the manual intervention, the user can be corrected in time when the user does not use the system correctly for learning/practicing. Or when the user achieves learning/practicing results, the results can be fed back to teachers and parents in time to praise the user, so as to improve the interest of the user in learning science.

The science teaching system of the present invention can also issue an assessment report according to the science learning/practicing situation of the user. The assessment report may comprise: the science multidimensional ability of the user, including the individual abilities in understanding, analysis, model/model group establishment, combination of knowledge points, step by step implementation, problem-solving path selection, problem-solving node combination, formula memory, calculation, concentration, psychology and proficiency, may also comprise a combination ability of two or more individual abilities, or a comprehensive ability of the science multidimensional ability of the user, and may also comprise a completion ability of the exercise or the combination thereof. The assessment report can also be a phased comparison report, or a progress report over a period of time, or a report on the achievement of a goal. The report can be for the user, teachers, parents, schools, extracurricular organizations, social organizations and work units, as the basis for the learning process/professional level evaluation of personnel/professional normative evaluation.

In the present invention, the data acquisition module 11, the analysis module 13 and the database module 12 can be installed on a server, and the assessment result and the recommended plans can be directly fed back to the display module or smart phone or computer of the user remotely through the network.

By adopting the science teaching system of the present invention, the user can formulate an individualized learning/practicing plan according to the actual situation of the user through the assessment and problem analysis of the science multidimensional ability, complete the corresponding learning/practicing plan, and achieve the learning/practicing goal of improving the science multidimensional ability of the user and the ability to skillfully complete more exercises.

The science teaching system of the present invention can also assess the science multidimensional ability of the user and the effect of the science teaching plan of the user at any time in the use process of the user, and adjust or re-recommend a science teaching plan suitable for the user according to the actual situation of science learning/practicing of the user, so that the user can always obtain a suitable science teaching plan and continuously and effectively improve the own science level when using the science teaching system of the present invention.

A second embodiment of the present invention is shown in FIG. 2. FIG. 2 is a method flow chart of a use method of a science teaching system in the second embodiment of the present invention. As shown in the figure, the method for using the science teaching system in the present invention comprises:
S1: obtaining data of science learning/practicing of the user;
S2: analyzing and assessing the science multidimensional ability of the user by mans of the data of science learning/practicing of the user;
S3: recommending a science teaching plan suitable for the user according to the science multidimensional ability of the user and the related information of the personal science learning/practicing of the user.

The method for using the science teaching system of the present invention corresponds to the technical features of the science teaching system of the present invention one by one, which can be known by referring to the description of the science teaching system above, and will not be repeated here.

The present invention further provides a computer-readable storage medium which stores a computer program, and the steps of the method for using the science teaching system are realized when the computer program is executed by a processor.

The computer-readable storage medium of the present invention corresponds to the technical features of the method for using the science teaching system and the science teaching system of the present invention, which can be known by referring to the description of the method for using the science teaching system and the science teaching system, and will not be repeated here.

In conclusion, in the science teaching system and the method for using same, and the computer-readable storage medium in the present invention, the science teaching system comprises: the data acquisition module, the analysis module and the database module. The method for using the science teaching system comprises: obtaining data of science learning/practicing of the user; analyzing and assessing the science multidimensional ability of the user by mans of the data of science learning/practicing of the user; and recommending a science teaching plan suitable for the user according to the science multidimensional ability of the user and the related information of the personal science learning/practicing of the user. In the science teaching system and the method for using same, and the computer-readable storage medium in the present invention, the data of science learning/practicing of the user is obtained by establishing the assessment standard of the science multidimensional ability to analyze and assess the science multidimensional ability of the user. A suitable, dynamic and individualized science teaching plan can be formulated for the user according to the personal ability and goal of the user, and the learning materials can be recommended; and the defect in the learning process of the user can also be intelligently analyzed, such that the user can perform a targeted correction, and thus the science learning of the user is efficient, convenient and low in cost.

The purposes, technical solutions and beneficial effects of the present invention are further described in detail through the above specific implementation modes. It shall be understood that the above only describes the specific implementation modes of the present invention and is not intended to limit the protection scope of the present invention. Any modification, equivalent replacement, improvement, etc. made within the spirit and the principle of the present invention shall be included within the protection scope of the present invention.

I claim:

1. A science teaching system, comprising: a data acquisition module, an analysis module and a database module, wherein
the data acquisition module is used for obtaining the data of science learning/practicing of a user;
the database module is used for storing a science multidimensional ability database and a user personal science database; the science multidimensional ability database comprises an assessment standard of the science multidimensional ability; and the user personal science database stores the related information of the personal science learning/practicing of the user;
the analysis module is used for analyzing and assessing the science multidimensional ability of the user through the data of science learning/practicing of the user and/or recommending a science teaching plan suitable for the user according to the science multidimensional ability of the user and the related information of personal science learning/practicing of the user.

2. The science teaching system according to claim 1, wherein the science multidimensional ability comprises at least one ability in understanding, analysis, model/model group establishment, combination of knowledge points, step by step implementation, problem-solving path selection, problem-solving node combination, formula memory, calculation, concentration, psychology and proficiency.

3. The science teaching system according to claim 2, further comprising setting corresponding levels/scores respectively according to the assessment results of each ability of the science multidimensional ability of the user, and setting a comprehensive analysis model of the multidimensional ability comprising the analysis results of each ability according to the actual situation of the user, so as to assess the corresponding levels/scores and the comprehensive analysis model which comprises the comprehensive analysis results and the relationship of each analysis item according to each ability of the user in the science multidimensional ability, wherein within a certain knowledge system, the levels/scores of the comprehensive science ability of the user are assessed for recommending a suitable science teaching plan for the user.

4. The science teaching system according to claim 1, wherein the science teaching plan comprises a learning plan and/or a practicing plan; the learning plan comprises learning of specific teaching content and review and summary of the specific teaching content after practicing; and the practicing plan comprises practicing goals, difficulty, exercises, practicing points, methods and skills, practicing time and completion standards.

5. The science teaching system according to claim 1, wherein the science multidimensional ability database further comprises marking the learning content/exercise sources on which the content/exercise is based, grade, course, difficulty, type, learning/problem-solving points, knowledge points involved, and formulas involved.

6. The science teaching system according to claim 1, which also recommends teaching video/audio/text/picture materials suitable for the user according to the science multidimensional ability of the user and the related information of personal science learning/practicing of the user.

7. The science teaching system according to claim 1, further comprising adjusting or re-recommending a science teaching plan suitable for the user according to the actual situation of the science learning/practicing of the user.

8. The science teaching system according to claim 1, which also performs intelligent analysis and feedback according to the actual situation of the science learning/practicing of the user, wherein the feedback comprises: at least one of feeding analysis results back to the user to enable the user to make targeted improvement; feeding the analysis results back to teachers/parents in real time so that the teachers/parents conduct manual intervention; and issuing an assessment report according to the analysis results.

9. A method for using the science teaching system of claim 1, comprising:
obtaining data of science learning/practicing of a user;
analyzing and assessing a science multidimensional ability of the user by means of the data of science learning/practicing of the user;
recommending a science teaching plan suitable for the user according to the science multidimensional ability of the user and related information of personal science learning/practicing of the user.

10. A computer-readable storage medium, storing a computer program, wherein the steps of the method for using the science teaching system of claim 9 are realized when the computer program is executed by a processor.
